(19) United States
(12) Patent Application Publication
(10) Pub. No.: US 2026/0133386 A1
(43) Pub. Date: May 14, 2026

(54) TECHNIQUES TO PREVENT UNDERFILL INTERFERENCE IN PHOTONIC FIBER COUPLERS

(71) Applicant: Lightmatter, Inc., Boston, MA (US)

(72) Inventors: Omkar Karhade, Chandler, AZ (US); Sufi Ahmed, Chandler, AZ (US)

(73) Assignee: Lightmatter, Inc., Boston, MA (US)

(21) Appl. No.: 19/386,524

(22) Filed: Nov. 12, 2025

Related U.S. Application Data
(60) Provisional application No. 63/720,034, filed on Nov. 13, 2024.

(51) Int. Cl. G02B 6/42

(52) U.S. Cl. CPC G02B 6/4228

(57) ABSTRACT

Described herein are robust fiber-connection structures for photonic integrated circuits (PICs). These fiber connection structures enable efficient optical coupling between integrated waveguides defined near an edge of a PIC and corresponding optical fibers, thereby facilitating reliable edge coupling. The fiber-connection designs developed by the inventor improve upon conventional approaches by minimizing damage associated die-sawing processes, reducing surface roughness and preventing underfill intrusion into the edge coupling region.

### CROSS-REFERENCE TO RELATED APPLICATION

This application claims the benefit under 35 U.S.C. § 119(e) of U.S. Provisional Application Ser. No. 63/720,034, filed on Nov. 13, 2024, under Attorney Docket No. L0858.70104US00 and entitled “3D DIE STACK WITH EDGE FIBER COUPLING WITHOUT CAPILLARY UNDERFILL INTERFERENCE,” which is hereby incorporated herein by reference in its entirety.

### BACKGROUND

Photonic integrated circuits (PICs) are microchips that use light to perform functions such as signal transmission, processing and sensing. PICs are typically singulated from a wafer using a die-saw process. PICs are typically very thin (e.g., less than 120 μm) and a high capillary underfill (CUF) or epoxy is conventionally used to increase the mechanical reliability of the PIC. A fiber attach unit (FAU) is an assembly that connects optical fibers to PIC. It precisely aligns and secures the fibers, often in an array, to ensure efficient optical coupling, mechanical stability, and protection of the fiber-PIC interface.

### BRIEF SUMMARY

In some aspects, the techniques described herein relate to a photonic package, including: a substrate; a photonic integrated circuit (PIC) attached to the substrate, wherein the PIC includes a ledge defined at an edge of the PIC, wherein the ledge is angled relative to a first sidewall of the PIC by an angle that is less than 90°; and an underfill between PIC and the substrate.

In some aspects, the techniques described herein relate to a photonic package, wherein the ledge extends between the first sidewall and a second sidewall of the PIC, wherein the first sidewall is in an etched-away region of the PIC and the second sidewall is outside the etched-away region of the PIC.

In some aspects, the techniques described herein relate to a photonic package, wherein the underfill: is in contact with the second sidewall, and is not in contact with the first sidewall.

In some aspects, the techniques described herein relate to a photonic package, wherein the PIC includes a waveguide extending towards the first sidewall of the PIC, wherein the waveguide is separated from the ledge by at least half a diameter of a fiber configured to couple to the PIC.

In some aspects, the techniques described herein relate to a photonic package, further includes an optical assembly including an optical fiber attached to a fiber attach unit (FAU), wherein the optical fiber is optically aligned to the waveguide of the PIC and the FAU overlaps with the ledge.

In some aspects, the techniques described herein relate to a photonic package, wherein the ledge is angled relative to the sidewall of the PIC by an angle that is between 75° and 89°.

In some aspects, the techniques described herein relate to a photonic package, further including an application-specific integrated circuit (ASIC) attached to the PIC, wherein the PIC is between the substrate and the ASIC.

In some aspects, the techniques described herein relate to a photonic package, wherein a top side of the ASIC is attached to a top side of the PIC.

In some aspects, the techniques described herein relate to a photonic package, further including a protector die attached to the substrate near the edge of the PIC.

In some aspects, the techniques described herein relate to a photonic package, wherein the protector die has a top surface that is at a same level as a top point of the ledge.

In some aspects, the techniques described herein relate to a photonic package, wherein the PIC includes a waveguide extending towards the first sidewall of the PIC, wherein the protector die has a top surface that is separated from the waveguide by at least half a diameter of a fiber configured to couple to the PIC.

In some aspects, the techniques described herein relate to a photonic package, further includes an optical assembly including an optical fiber attached to a fiber attach unit (FAU), wherein the optical fiber is optically aligned to the waveguide of the PIC and the FAU overlaps in part with the ledge and in part with the top surface of the protector die.

In some aspects, the techniques described herein relate to a photonic package, wherein the underfill is further between protector die and the substrate.

In some aspects, the techniques described herein relate to a photonic package, wherein the underfill is further between protector die and the PIC.

In some aspects, the techniques described herein relate to a photonic package, including: a substrate; a photonic integrated circuit (PIC) attached to the substrate, wherein the PIC includes a ledge defined at an edge of the PIC; a protector die attached to the substrate near the edge of the PIC; and an underfill between PIC and the substrate.

In some aspects, the techniques described herein relate to a photonic package, wherein the underfill is further between protector die and the PIC.

In some aspects, the techniques described herein relate to a photonic package, wherein the protector die has a top surface that is at a same level as a top surface of the ledge.

In some aspects, the techniques described herein relate to a photonic package, wherein the PIC includes a waveguide extending towards the edge of the PIC, wherein the protector die has a top surface that is separated from the waveguide by at least half a diameter of a fiber configured to couple to the PIC.

In some aspects, the techniques described herein relate to a photonic package, further includes an optical assembly including an optical fiber attached to a fiber attach unit (FAU), wherein the optical fiber is optically aligned to the waveguide of the PIC and the FAU overlaps in part with the ledge and in part with the top surface of the protector die.

In some aspects, the techniques described herein relate to a photonic package, wherein the protector die is a passive die.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a cross sectional view illustrating a package including a photonic integrated circuit (PIC) edge coupled to an optical fiber.

FIG. 2 is a cross sectional view illustrating a package including a PIC defining a solder dam.

FIG. 3A is a cross sectional view illustrating a package including a PIC defining a ledge configured to prevent underfill from reaching the edge coupling region, in accordance with some embodiments.

FIG. 3B is a cross sectional view illustrating a portion of the package of FIG. 3A in additional detail, in accordance with some embodiments.

FIG. 4A is a cross sectional view illustrating a package including a PIC defining a ledge and a protector die disposed near the PIC, in accordance with some embodiments.

FIG. 4B is a cross sectional view illustrating a portion of the package of FIG. 4A in additional detail, in accordance with some embodiments.

FIG. 4C is a top view illustrating the package of FIG. 4A, in accordance with some embodiments.

FIGS. 5A-5H are cross sectional views illustrating a process for fabricating the package of FIG. 4A, in accordance with some embodiments. In the fabrication step corresponding to FIG. 5A, a PIC is disposed on a carrier. In the fabrication step corresponding to FIG. 5B, a trench is defined through the PIC. In the fabrication step corresponding to FIG. 5C, a PIC die-saw channel is defined in the trench. In the fabrication step corresponding to FIG. 5D, application-specific integrated circuits (ASICs) are disposed on the PIC. In the fabrication step corresponding to FIG. 5E, underfill is formed between the PIC and the ASICs. In the fabrication step corresponding to FIG. 5F, the PIC and a protector die are disposed on a substrate. In the fabrication step corresponding to FIG. 5G, underfill is formed between the PIC and the substrate. In the fabrication step corresponding to FIG. 5H, a fiber is attached to the PIC.

### DETAILED DESCRIPTION

Described herein are robust fiber-connection structures for photonic integrated circuits (PICs). These fiber connection structures enable efficient optical coupling between integrated waveguides defined near an edge of a PIC and corresponding optical fibers, thereby facilitating reliable edge coupling. The fiber-connection designs developed by the inventor improve upon conventional approaches by minimizing damage associated die-sawing processes, reducing surface roughness and preventing underfill interference into the edge coupling region.

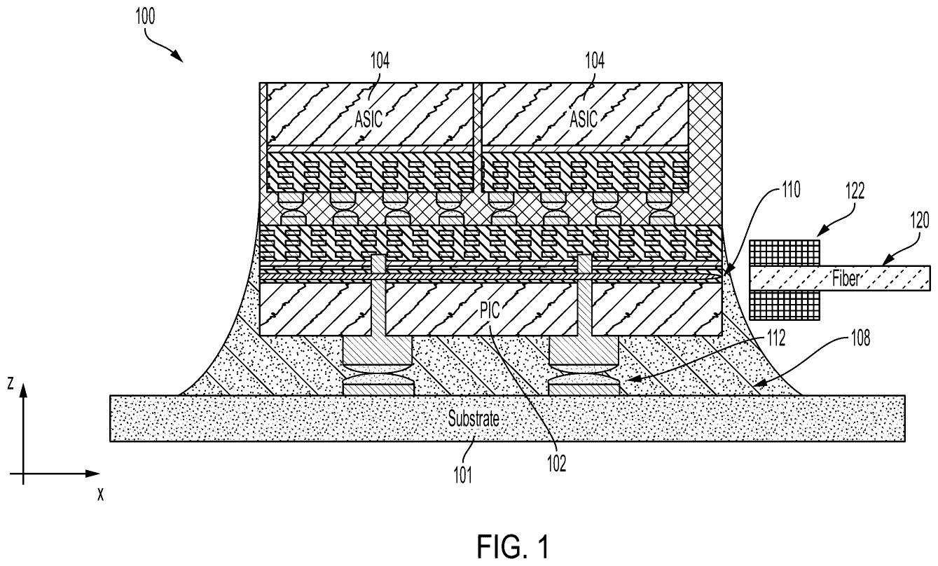

Conventional PIC-fiber connections have several limitations. A common approach involves singulation of PICs using a die saw process, in which a rotating blade cuts along a predefined line to separate individual chips from a semiconductor wafer. This cutting process not only defines the physical boundary of the chip but also exposes the end of a waveguide located near the dicing edge, thereby forming an edge-coupling interface where an optical fiber can be aligned to the waveguide core. An underfill (e.g., epoxy or a capillary underfill (CUF)) is formed near the region of the edge coupler to provide mechanical stability and environmental protection. The inventor has recognized and appreciated that the underfill is driven by surface tension and viscosity, and as a result, balances surface tension at all open surfaces. This results in the underfill covering the edge coupling region, thereby reducing the coupling efficiency. Additionally, the use of die sawing can cause surface roughness and chipping at the exposed facet, thereby degrading performance and yield. FIG. 1 is a cross sectional view illustrating a conventional package 100 including a PIC 102 edge coupled to an optical fiber 120. PIC 102 is attached to a substrate 101. PIC 102 may be extracted from a larger photonic substrate through a singulation process, for example using a die saw. Bumps 112 permit electrical communication between PIC 102 and substate 101. An underfill 108 surrounds bumps 112 and fills the volume between PIC 102 and substrate 101. The underfill may be epoxy or a high capillary underfill (CUF), for example. A fiber 120 is coupled to edge coupler 110 of PIC 102, thereby permitting optical modes to couple from fiber 120 to PIC 102, and vice versa. A fiber attach unit (FAU) 122 supports fiber 120 and allows fiber 120 to be aligned to edge coupler 110 with sub-micron precision. A pair of application-specific integrated circuits (ASICs) 104 is disposed on top of PIC 102. It should be noted that edge coupler 110 is partially covered with underfill 108, thereby reducing the efficiency of the optical coupler. Additionally, the die saw process used to singulate PIC 102 may damage or contaminate the edge of PIC 102, further reducing the coupling efficiency.

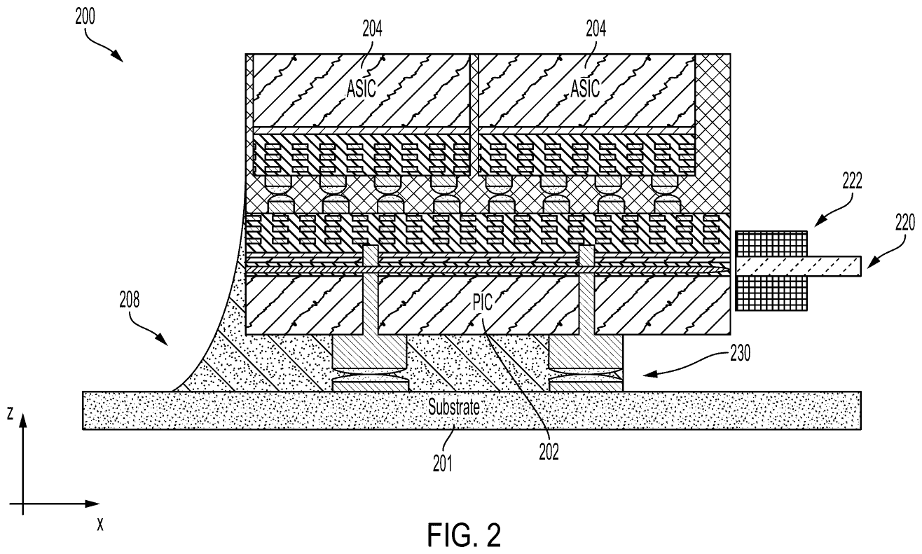

Another conventional approach involves “solder dams,” whereby side rows of solder bumps are shorted together to drive the underfill preferentially along the y-axis direction (the direction into the page in FIG. 1). FIG. 2 illustrates this approach. FIG. 2 is a cross sectional view illustrating a package 200 including a PIC defining a solder dam. Substrate 201, PIC 202, ASICs 204, fiber 220 and FAU 222 are arranged in the same way as described above in connection with FIG. 1. In this implementation, however, solder bumps 230 act as a dam, preventing underfill 208 from interfering with the edge coupler. The inventor has appreciated that this approach addresses sidewall degradation due to the underfill, but results in a number of additional issues. First, the fact that the underfill does not cover the die edges may result in higher stress, reducing structural reliability. Second, valuable solder bump real estate is wasted to create the dams. Third, for mass reflow it is difficult to simultaneously optimize height of the solder dams and the height of the neighboring bumps, which can cause opens or shorts. Fourth, it is difficult to deflux a die fabricated in this way because water flow is restricted in two directions. Fifth, the solder dam may cause underfill voids due to flux residue next to the dam or due to flow restrictions on the dam. Lastly, the solder dam is not a fool proof solution—the underfill may still flow outside when large amounts of underfill are used, which can often be necessary to adequately mitigate higher stress in larger dies.

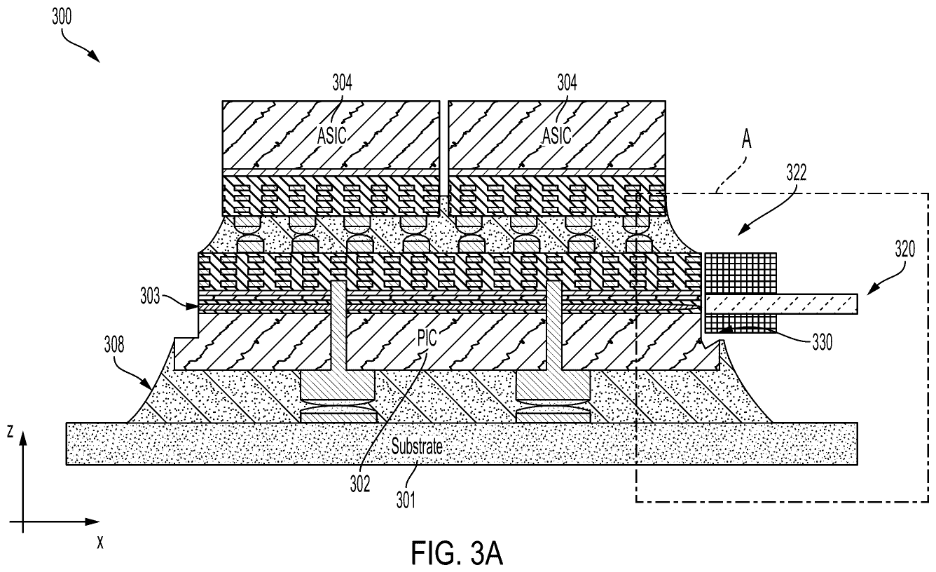

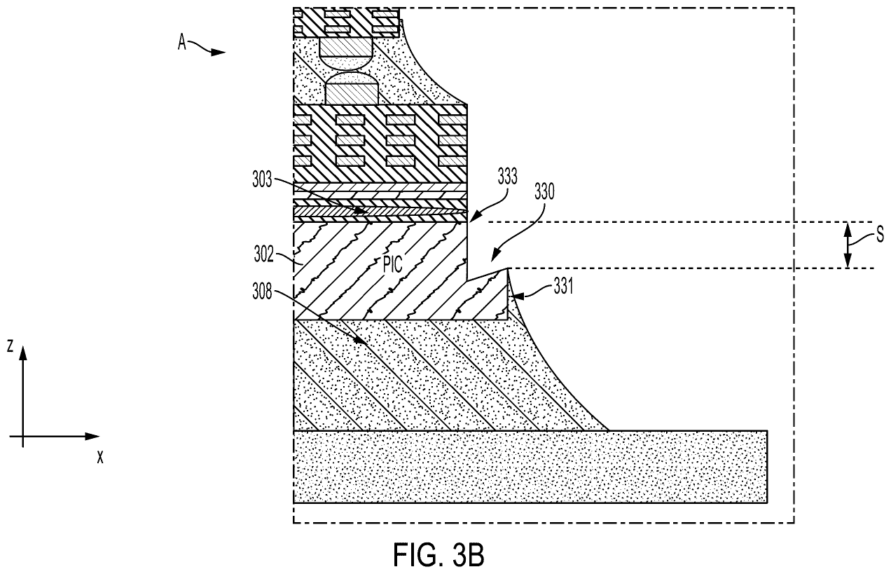

The PIC-fiber connections developed by the inventor and described herein reduce saw damage to the edge coupler and prevent underfill from climbing and interfering with the edge coupler. These effects can be achieved in some embodiments by etching an edge of the PIC to create a smooth, vertical surface at the location of the end of a waveguide in the PIC (e.g., the edge coupler). The etched edge forms a ledge on which a fiber connector can be placed. Additionally, the ledge is further processed (e.g., etched) to define a surface that is angled relative to the plane of the PIC. These steps result in a sharp corner at the edge of the PIC, creating a barrier that prevents underfill from spilling over because of surface tension. FIGS. 3A-3B illustrate an example of a package 300 embodying this concept. FIG. 3A is a cross sectional view illustrating a package including a PIC defining an angled ledge configured to prevent underfill from reaching the edge coupling region, and FIG. 3B is a cross sectional view illustrating a portion of the package of FIG. 3A (labelled “A”) in additional detail, in accordance with some embodiments.

Substrate 301, PIC 302, ASICs 304, fiber 320 and FAU 322 are arranged in the same way as described above in connection with FIG. 1. In this implementation, however, an etched-away region is formed at the edge of PIC 302. The etched-away region defines an angled ledge 330 having a surface that is angled relative to the xy-plane (the angle is exaggerated for purposes of illustration). As further illustrated in FIG. 3B, in which FAU 322 has been removed for purposes of illustration, angled ledge 330 extends from the PIC's sidewall 331 to the PIC's sidewall 333. Sidewall 333 represents the sidewall of PIC 302 in the etched-away region while sidewall 331 represents the sidewall of PIC 302 outside the etched-away region. As shown, waveguide 303 extends towards sidewall 333 and the end of waveguide 303 is located within the etched-away region of PIC 302. The angle between the plane defined by ledge 330 and the plane defined by sidewall 333 (which is parallel to the zy-plane) is less than 90° (e.g., between 50° and 89°, between 50° and 85°, between 50° and 80°, between 60° and 89°, between 60° and 85°, between 60° and 80°, between 70° and 89°, between 70° and 85°, between 70° and 80°, between 75° and 89°, between 75° and 85°, or between 75° and 80°). The angled ledge is oriented in the inwards direction, towards sidewall 333. As a result, the angled ledge creates a barrier preventing underfill 308 from spilling into the edge coupling region. The barrier allows underfill 308 to be in contact with sidewall 331, but prevents it from contacting sidewall 333.

The vertical separation S between the plane of waveguide 303 and the highest point of ledge 330 may be sufficiently large to allow FAU 332 and fiber 320 to fit in the etched-away region while ensuring optical alignment between the waveguide and the fiber. For example, vertical separation S may be at least 62.5 μm, equaling half of the diameter of a conventional fiber (i.e., 125 μm). In another example, vertical separation S may be at least 40 μm, equaling half of the diameter of a smaller type of fiber (i.e., 80 μm).

Referring back to FIG. 3A, FAU 322 overlaps with ledge 330 when the FAU is attached to the package. For example, at least a portion of FAU 322 may occupy the space immediately above (along the z-axis) ledge 330.

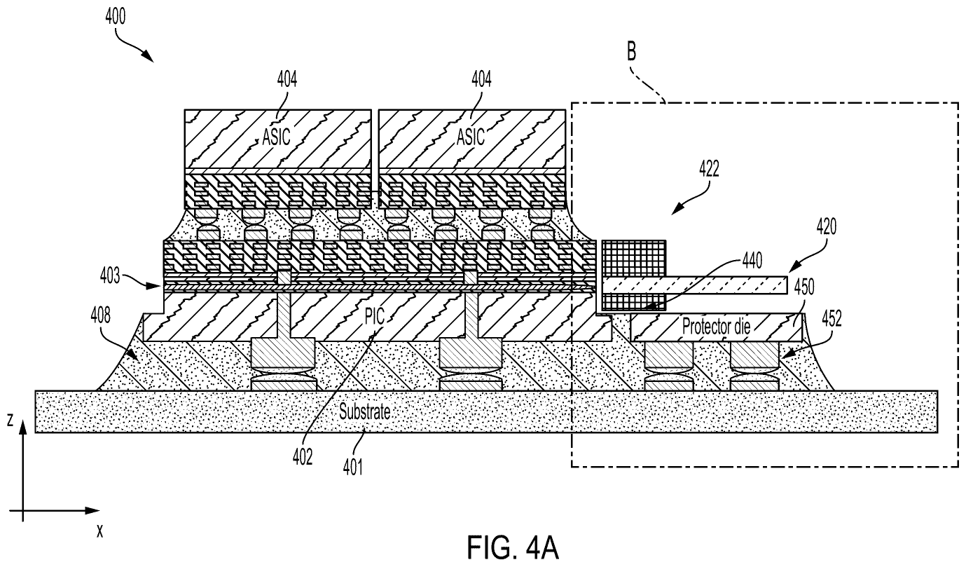

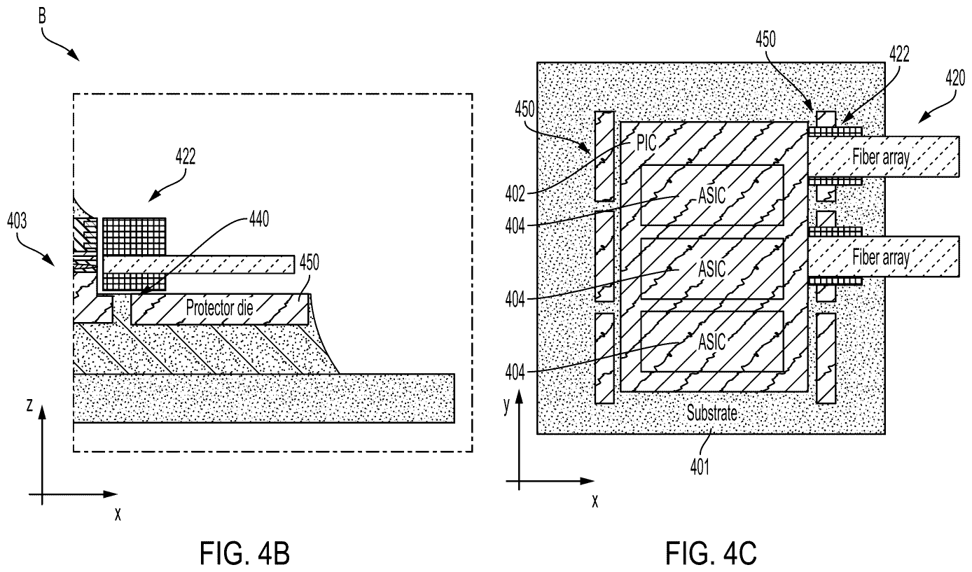

The inventor has further recognized and appreciated that using an additional die, referred to as a “protector die,” provides further benefits. The protector die permits use of underfill in greater quantity, thereby improving mechanical stability, while mitigating the spill-over effect described above. Additionally, the protector die reduces stress on the PIC and provides a flat surface allowing fiber bonding to the PIC. FIG. 4A is a cross sectional view illustrating a package including a protector die, and FIG. 4B is a cross sectional view illustrating a portion of the package of FIG. 4A (labelled “B”) in additional detail, in accordance with some embodiments. Although FIGS. 4A-4B illustrate examples in which the ledge of the PIC is parallel to the xy-plane, in some embodiments, a protector die may be used in conjunction with the angled ledge described in connection with FIG. 3A-3B to further mitigate the spill-over effect.

Substrate 401, PIC 402, ASICs 404, fiber 420 and FAU 422 are arranged in the same way as described above in connection with FIG. 1. In this implementation, however, a protector die 450 is disposed near PIC 402. Protector die 450 defines a top surface 440 that, in this depiction, is at the same level as the ledge of the PIC. For example, in embodiments in which the ledge is parallel to the xy-plane, top surface 440 may be at the same level as the top surface of the ledge. Alternatively, in embodiments in which the ledge is angled, top surface 440 may be at the same level as the top point of the ledge. In such embodiments, a side of the protector die may have a wedge configured to line up with the angled ledge of the PIC.

In other implementations, top surface 440 and the PIC ledge may be slightly misaligned. For example, top surface 440 may be lower (closer to the substrate) than the PIC ledge waveguide in some embodiments. To provide sufficient space to optically align fiber 420 with waveguide 403, the top surface 440 of the protector die may be separated from waveguide 403 by at least 40 μm or at least 62.5 um in the vertical (z-axis) direction. In some embodiments, when fiber 420 is optically coupled with waveguide 403, FAU 422 overlaps in part with the ledge of the PIC and in part with top surface 440.

Bumps 452 permit electrical communication between protector die 450 and substrate 401, if desired. This may be useful in embodiments in which protector die 450 includes circuitry (e.g., deep trench capacitor, inductors, etc.). In other embodiments, bumps 452 may be omitted; instead, protector die 450 is glued directly to substrate 401. In some embodiments, protector die 450 is passive.

The presence of protector die 450 prevents the propagation of any cracks/delamination originating from the use of a saw. Additionally, the presence of protector die 450 prevents underfill 408 from interfering with the fiber coupler. This is because surface tension prevents underfill 408 from climbing beyond the top surface of protector die 450. The underfill is disposed between the protector die and the substrate, and optionally, between the PIC and protector die if there is enough space between the protector die and the PIC. Additionally, protector die 450 provides mechanical support to the die edges (representing high stress points) and provides a flat surface for fiber attach.

It should be noted that while protector die 450 increases the size of the package, most fiber connectors require space on the side of the PIC regardless of whether a protector die is used or not. As such, the additional space occupied by protector die 450 has a low impact.

FIG. 4C is a top view illustrating the package of FIG. 4A in additional detail, in accordance with some embodiments. In this implementation, the package includes three ASICs 404 disposed on top of a PIC 402, and six FAUs 422. For each FAU, there is a protector die 450 disposed near the corresponding edge of PIC 402. Three protector dies 450 are disposed near one edge of PIC 402; three additional protector dies 450 are disposed near the opposite edge of PIC 402.

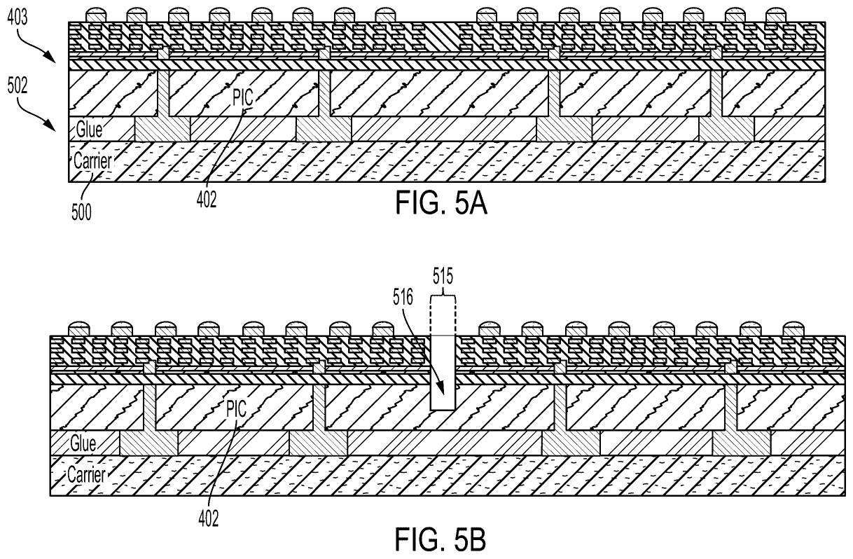

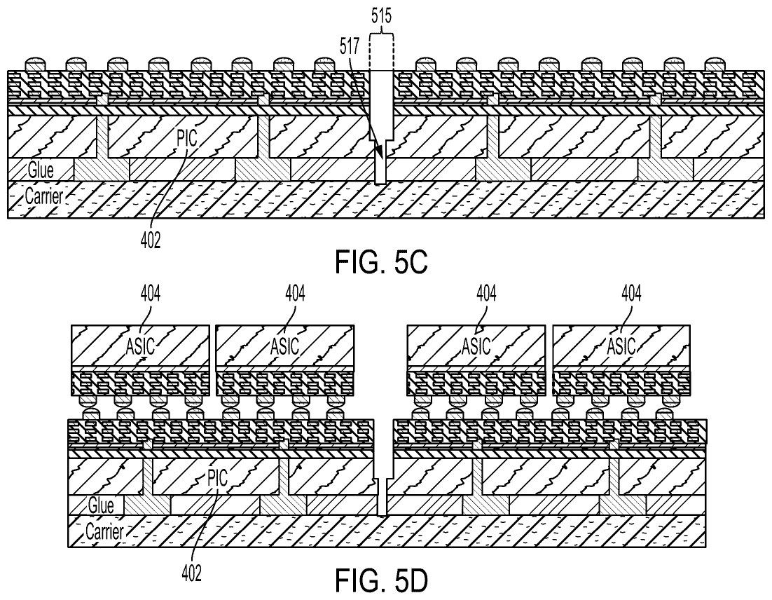

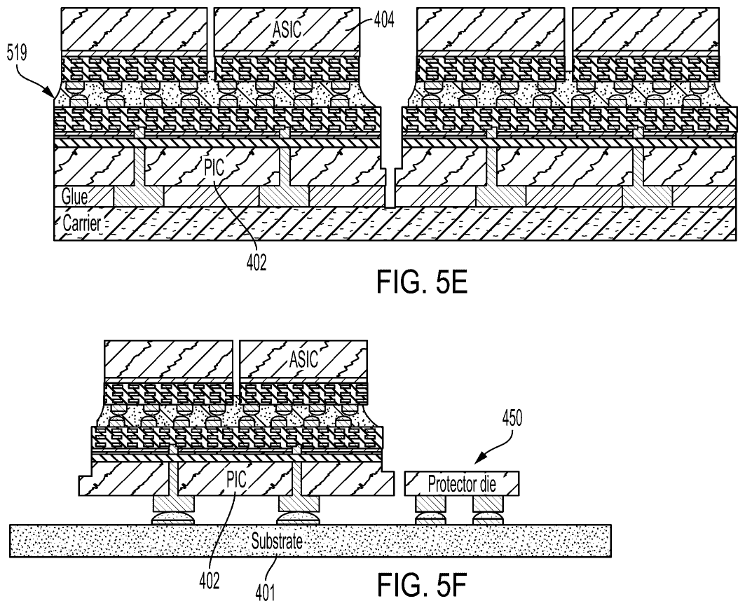

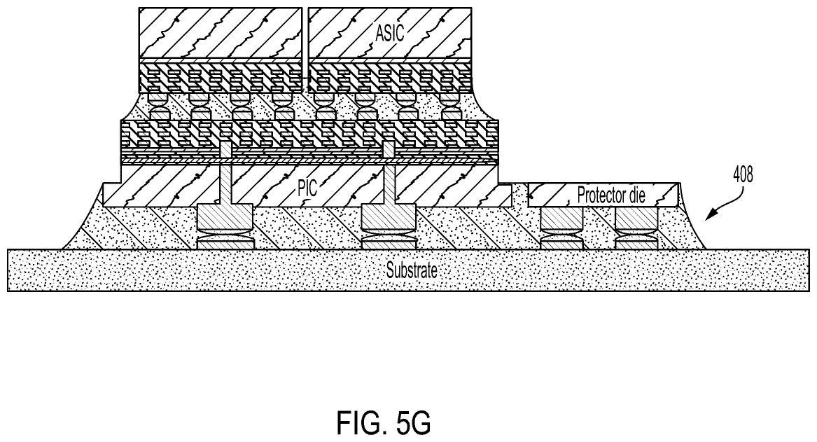

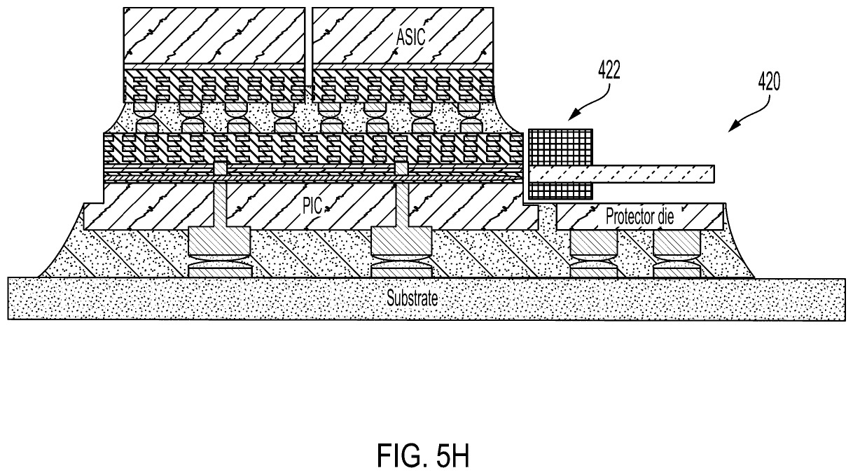

FIGS. 5A-5H are cross sectional views illustrating a process for fabricating the package of FIG. 4A, in accordance with some embodiments. The fabrication process begins at the step corresponding to FIG. 5A, in which a PIC 402 is provided on a temporary carrier 500. Waveguides 403 are formed as part of PIC 402. At this stage, PIC 402 may be in the shape of a semiconductor wafer that is patterned with multiple instantiations (reticles) of a master photonic circuit. As will be described in detail further below, individual PICs are ultimately singulated from the wafer. PIC 402 is attached to carrier 500 by glue 502.

In the fabrication step corresponding to FIG. 5B, a trench 515 is defined through the PIC wafer, forming a ledge 516. Trench 515 may be formed lithographically using reactive ion etching (RIE) techniques. Ledge 516 may be positioned in the region between two reticles of the wafer.

In the fabrication step corresponding to FIG. 5C, a PIC die-saw channel 517 is defined at the bottom of trench 515. Channel 517 may also be formed lithographically using RIE techniques.

In the fabrication step corresponding to FIG. 5D, application-specific integrated circuits (ASICs) 404 are disposed on top of PIC 402. In this example, the chips are flip-chip bonded; as such, the top side of PIC 402 is attached to the top side of ASICs 404 (the top side being defined as the side that is opposite the chip substrate).

In the fabrication step corresponding to FIG. 5E, underfill 519 is formed between the PIC and the ASICs. In the fabrication step corresponding to FIG. 5F, an individual PIC is singulated from the original PIC wafer. The PIC is removed from temporary carrier 500 and is ultimately placed on substrate 401. Additionally, a protector die 450 is placed on substrate 401 near PIC 402. Protector die 450 may be attached to substrate 401 through bumps (as shown in FIG. 5F), or may be attached to substate 401 directly (e.g., with glue).

In the fabrication step corresponding to FIG. 5G, underfill 408 is formed between PIC 402 and substrate 401. The presence of protector die 450 prevents underfill 408 from interfering with the PIC's fiber coupler because surface tension prevents underfill 408 from climbing beyond the top surface of protector die 450.

In the fabrication step corresponding to FIG. 5H, an assembly including a fiber 420 connected to an FAU 422 is coupled to the edge of PIC 402. As shown, part of FAU 422 overlaps with the PIC's ledge and part of FAU 422 overlaps with the top surface of protector die 450.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A photonic package, comprising:
a substrate;
a photonic integrated circuit (PIC) attached to the substrate, wherein the PIC comprises a ledge defined at an edge of the PIC, wherein the ledge is angled relative to a first sidewall of the PIC by an angle that is less than 90°; and
an underfill between PIC and the substrate.

2. The photonic package of claim 1, wherein the ledge extends between the first sidewall and a second sidewall of the PIC, wherein the first sidewall is in an etched-away region of the PIC and the second sidewall is outside the etched-away region of the PIC.

3. The photonic package of claim 2, wherein the underfill:
is in contact with the second sidewall, and
is not in contact with the first sidewall.

4. The photonic package of claim 1, wherein the PIC comprises a waveguide extending towards the first sidewall of the PIC, wherein the waveguide is separated from the ledge by at least half a diameter of a fiber configured to couple to the PIC.

5. The photonic package of claim 4, further comprising an optical assembly comprising an optical fiber attached to a fiber attach unit (FAU), wherein the optical fiber is optically aligned to the waveguide of the PIC and the FAU overlaps with the ledge.

6. The photonic package of claim 1, wherein the ledge is angled relative to the sidewall of the PIC by an angle that is between 75° and 89°.

7. The photonic package of claim 1, further comprising an application-specific integrated circuit (ASIC) attached to the PIC, wherein the PIC is between the substrate and the ASIC.

8. The photonic package of claim 7, wherein a top side of the ASIC is attached to a top side of the PIC.

9. The photonic package of claim 1, further comprising a protector die attached to the substrate near the edge of the PIC.

10. The photonic package of claim 9, wherein the protector die has a top surface that is at a same level as a top point of the ledge.

11. The photonic package of claim 9, wherein the PIC comprises a waveguide extending towards the first sidewall of the PIC, wherein the protector die has a top surface that is separated from the waveguide by at least half a diameter of a fiber configured to couple to the PIC.

12. The photonic package of claim 11, further comprising an optical assembly comprising an optical fiber attached to a fiber attach unit (FAU), wherein the optical fiber is optically aligned to the waveguide of the PIC and the FAU overlaps in part with the ledge and in part with the top surface of the protector die.

13. The photonic package of claim 9, wherein the underfill is further between protector die and the substrate.

14. The photonic package of claim 13, wherein the underfill is further between protector die and the PIC.

15. A photonic package, comprising:
a substrate;
a photonic integrated circuit (PIC) attached to the substrate, wherein the PIC comprises a ledge defined at an edge of the PIC;
a protector die attached to the substrate near the edge of the PIC; and
an underfill between PIC and the substrate.

16. The photonic package of claim 15, wherein the underfill is further between the protector die and the PIC.

17. The photonic package of claim 15, wherein the protector die has a top surface that is at a same level as a top surface of the ledge.

18. The photonic package of claim 15, wherein the PIC comprises a waveguide extending towards the edge of the PIC, wherein the protector die has a top surface that is separated from the waveguide by at least half a diameter of a fiber configured to couple to the PIC.

19. The photonic package of claim 18, further comprising an optical assembly comprising an optical fiber attached to a fiber attach unit (FAU), wherein the optical fiber is optically aligned to the waveguide of the PIC and the FAU overlaps in part with the ledge and in part with the top surface of the protector die.

20. The photonic package of claim 15, wherein the protector die is a passive die.
